(19) United States
(12) Patent Application Publication
(10) Pub. No.: US 2010/0095862 A1
(43) Pub. Date: Apr. 22, 2010

(54) Double Sidewall Angle Nano-Imprint Template

(75) Inventors: Michael N. Miller, Austin, TX (US); John Thomas Cowher, Austin, TX (US); Cynthia B. Brooks, Austin, TX (US); Dwayne L. LaBrake, Cedar Park, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/582,471

(22) Filed: Oct. 20, 2009

Related U.S. Application Data
(60) Provisional application No. 61/107,390, filed on Oct. 22, 2008.

(51) Int. Cl. B41N 1/00; B41N 3/00

(52) U.S. Cl. 101/453; 101/463.1

(57) ABSTRACT

The present application describes a template with feature profiles that have multiple sidewall angles. The multiple sidewall angles facilitate control over critical dimensions and reduce issues related to template release.

### CROSS RELATION TO RELATED APPLICATION

This application claims priority to U.S. Provisional Patent Application No. 61/107,360 filed Oct. 22, 2008, which is hereby incorporated by reference herein.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Application Publication No. 2004/0065976, U.S. Patent Application Publication No. 2004/0065252, and U.S. Pat. No. 6,936,194, all of which are hereby incorporated by reference herein.

An imprint lithography technique disclosed in each of the aforementioned U.S. patent application publications and patent includes formation of a relief pattern in a formable (polymerizable) layer and transferring a pattern corresponding to the relief pattern into an underlying substrate. The substrate may be coupled to a motion stage to obtain a desired positioning to facilitate the patterning process. The patterning process uses a template spaced apart from the substrate and the formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of a lithographic system in accordance with embodiments of the present invention.

FIG. 2 illustrates a simplified side view of the substrate shown in FIG. 1 having a patterned layer positioned thereon.

FIGS. 3A-F illustrate a simplified view of a process flow for fabricating a template in accordance with embodiments of the present invention.

FIG. 4 illustrates a flowchart for fabricating a template.

### DETAILED DESCRIPTION

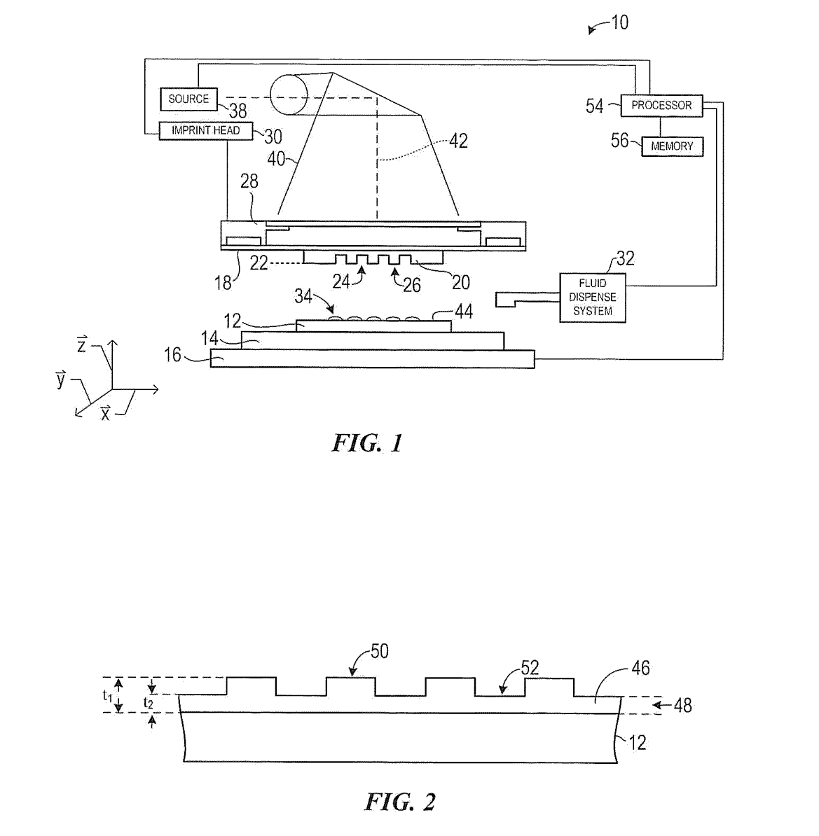

Referring to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference herein.

Substrate 12 and substrate chuck 14 may be further supported by stage 16. Stage 16 may provide motion along the x-, y-, and z-axes. Stage 16, substrate 12, and substrate chuck 14 may also be positioned on a base (not shown).

Spaced-apart from substrate 12 is a template 18. Template 18 generally includes a mesa 20 extending therefrom towards substrate 12, mesa 20 having a patterning surface 22 thereon. Further, mesa 20 may be referred to as mold 20. Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Exemplary chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 20 and substrate 12 depending on design considerations. Polymerizable material 34 may comprise a monomer mixture as described in U.S. Pat. No. 7,157,036 and U.S. Patent Application Publication No. 2005/0187339, all of which are hereby incorporated by reference herein.

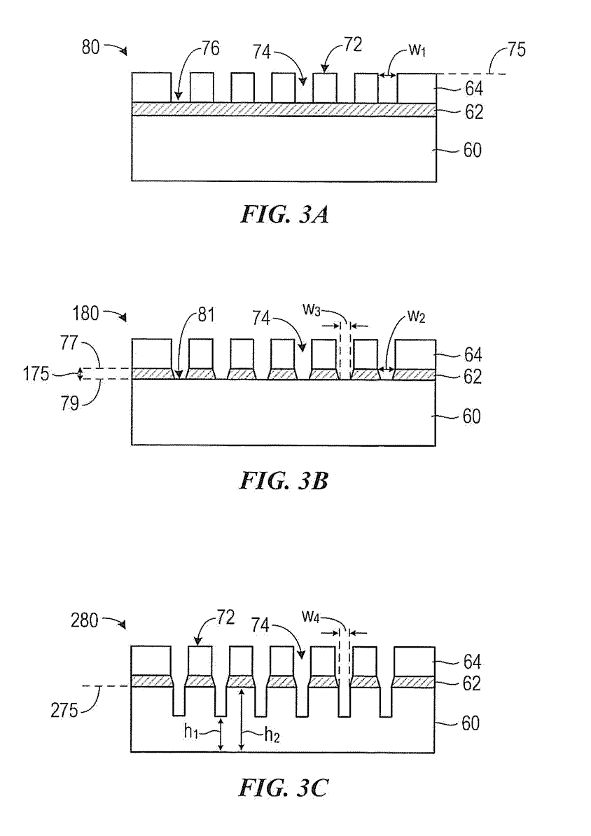

Referring to FIGS. 1 and 2, system 10 may further comprise an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46 on substrate 12. Patterned layer 46 may comprise a residual layer 48 and a plurality of features shown as protrusions 50 and recessions 52, with protrusions 50 having a thickness t₁ and residual layer 48 having a thickness t₂.

The above-described system and process may be further implemented in imprint lithography processes and systems referred to in U.S. Pat. No. 6,932,934, U.S. Patent Application Publication No. 2004/0124566, U.S. Patent Application Publication No. 2004/0188381, and U.S. Patent Application Publication No. 2004/0211754, each of which is hereby incorporated by reference herein.

During nano-imprint processing, physical separation of template 18 from patterned layer 46 may sometimes result in cohesive failure of patterned layer 46, particularly when the aspect ratio of the features (protrusions 50 and recessions 52) of patterned layer 46 is high (i.e., greater than 2:1). The cohesive failure can be observed at the base of the resist feature (e.g., protrusion 50 and recessions 52), where the feature (e.g., protrusion 50 and recession 52) attaches to residual layer 48.

More specifically, upon separation of template 18 from patterned layer 46, forces such as adhesive forces may be present between template 18 and patterned layer 46, and more specifically, between mold 20 and protrusions 50 and recessions 52. The adhesive forces therebetween may be of such a magnitude that upon separation of template 18 and patterned layer 46, the features (protrusions 50 and recession 52), of patterned layer 46 may be compromised, distorted, or damaged. To that end, it may be desired to reduce, if not prevent, any undesirable alterations to the features of patterned layer 46 upon separation of template 18 from patterned layer 46.

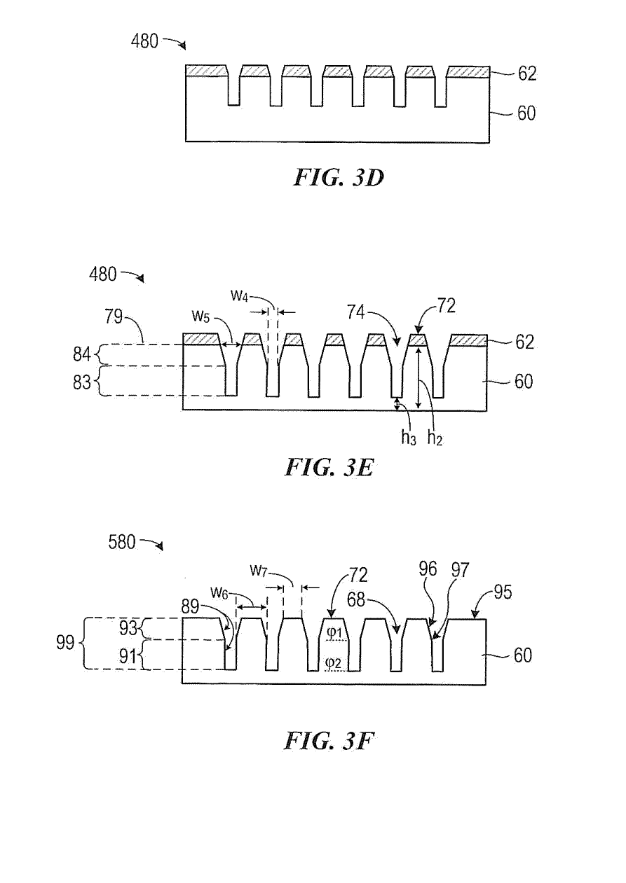

FIGS. 3A-F illustrate an embodiment of the present application, which produces a template with a feature profile that has a shallower sidewall angle at the base of the resist feature (protrusions 50 and recession 52) where cohesive failure is likely to occur, while maintaining a more vertical sidewall near the middle to top part of the resist feature where pattern transfer is typically defined.

Referring to FIG. 3A, a multi-layered structure 80 is shown. Multi-layered structure 80 may be employed to form template 18, which is described below. Multi-layered structure 80 comprises a body 60, a hardmask layer 62, and a patterned layer 64, with hardmask layer 62 being positioned between body 60 and patterned layer 64. In an embodiment, body 60 may be formed from fused silica. In an embodiment, hardmask layer 62 may be formed from a metal such as chromium and further sputtered-coated on body 60 to a thickness of 5-15 nanometers. In an embodiment, patterned layer 64 may comprise a plurality of protrusions 72 and recessions 74 defining a pattern 75, with recessions 74 exposing portions 76 of hardmask layer 62. Further recessions 74 may have a first width w₁ associated therewith. In an embodiment, patterned layer 64 may be a position-tone electron beam resist, such as ZEP520A available from Nippon Zeon Corporation.

In an example, electron beam lithography may be employed to form pattern 75 in patterned layer 64. Thus, areas that are imaged by the electron beam (recessions 74) may be soluble in a developer solution. Such solutions may comprise, but is not limited to, amyl acetate and xylenes.

Referring to FIG. 3B, multi-layered structure 80 may be subjected to an etching process to transfer the features thereof into hardmask layer 62, defining multi-layered structure 180. More specifically, pattern 75 of patterned layer 64 may be transferred into hardmask layer 62, and thus segments of exposed portions 76 of hardmask layer 62, shown in FIG. 3a, may be removed, defining a pattern 175 within hardmask layer 62, with recessions 74 exposing portions 81 of body 60. Segments of exposed portion 76 of hardmask layer 62 may be removed such that recessions 74 may have a second width w₂ at an interface 77 of hardmask layer 62 and patterned layer 64 and a third width w₃ at an interface 79 of hardmask layer 62 and body 60, with the hardmask layer 62 varying in width therebetween. In an implementation, the varying of the width of hardmask layer 62 is substantially linear; however in a further implementation, the varying of the width of hardmask layer 62 may substantially not be linear. The second width w₂ may be substantially the same as the first width w₁, and the third width w₃ may be less than the first width w₁ or the second width w₂. To that end, the etching process may be a chlorine/oxygen reactive ion etch (RIE) including both single step and multi-step processes.

Referring to FIG. 3C, multi-layered structure 180, shown in FIG. 3B, may be subjected to an etching process to transfer the features thereof into body 60, defining multi-layered structure 280. More specifically, pattern 175 of hardmask layer may be transferred into body 60, and thus segments of exposed portions 81 of body 60, shown in FIG. 3B, may be removed, defining a pattern 275 within body 60. Segments of exposed portions 81 may be removed such that recessions 74 have a fourth width w₄ with respect to body 60. The fourth width w₄ may be substantially the same as the third width w₃. Further, segments of exposed portions 81 may be removed such that body 60 has a first height h₁ in superimposition with recessions 74 and a second height h₂ in superimposition with protrusions 72. To that end, the etching process may be a dry etching process comprising a fluorine-based etch using Freon-23 (trifluoromethane, CHF₃) or sulfur hexafluoride (SF₆) combined with an inert diluent, such as argon or nitrogen.

Referring to FIG. 3D, patterned layer 64 may be removed, defining multi-layered structure 380. The patterned layer 64, shown in FIG. 3C, may be removed employing a low power oxygen-rich RIE.

Referring to FIG. 3E, multi-layered structure 380 may be subjected to a further etching process to further define features in body 60, defining multi-layered structure 480. More specifically, protrusions 72 are subjected to an etching process such that recessions 74 in superimposition with a first section 83 of body 60 have the fourth width w₄ and recessions 74 at interface 79 of hardmask layer 62 and body 60 having a fifth width w₅, with recessions 74 in superimposition with a second section 84 of body 60 having a varying width between the fourth width w₄ and the fifth width w₅. In an implementation, the varying of the width of second section 84 is substantially linear; however, in a further embodiment, the varying of the width of second section 84 is not substantially linear. Moreover, segments of exposed portions 81 of body 60 in superimposition with recessions 74 may be further removed such that body 60 has a third height h₃ in superimposition with recessions 74. This is analogous to deepening recessions 74.

Referring to FIG. 3F, hardmask layer 62, shown in FIG. 3E, may be removed, defining multi-layered structure 580. The hardmask layer 62, shown in FIG. 3E, may be removed employing a chromium wet etch, such as a ceric ammonium nitrate solution.

To that end, multi-layered structure 580 is shown having protrusions 72 having a sidewall 89, with sidewall 89 having a varied width associated therewith. More specifically, a first segment 91 of protrusions 72 has a sixth width w₆ associated therewith. Sixth width w₆ is substantially constant throughout first segment 91 of protrusions 72. Further, protrusions 72 have a seventh width w₇ at a surface 95 thereof, with a second segment 93 of protrusions 72 having a varying width between the sixth width w₆ and the seventh width w₇. Second segment 93 is positioned between first segment 91 and surface 95. In an implementation, the varying of the width of second segment 93 of protrusions 72 is substantially linear; however, in a further embodiment, the varying of the width of second segment 93 of protrusions 72 is not substantially linear. The seventh width w₇ may be less than the sixth width w₆.

Further, an angle φ₁ of portion 96 of sidewall 89 with respect to the horizontal may be approximately 45°; and in a further embodiment, may be within a range of approximately 45°-80°; and in still a further embodiment, may be within a range of approximately 60°-70°. Moreover, the angle φ₁ of portion 96 of sidewall 89 is chosen to facilitate a low release force with respect to patterned layer 46. Further, an angle φ₂ of portion 97 of sidewall 89 with respect to the horizontal may be approximately 90°; however in a further embodiment, may be within a range of approximately 80°-90°; and in still a further embodiment, may be within a range of approximately 85°-89°.

To that end, multi-layered structure 580 corresponds to template 18 shown in FIG. 1. Template 18 corresponds to body 60; mesa/mold 20 corresponds to mesa/mold 99; recess 24 corresponds to recess 74; and protrusion 26 corresponds to protrusion 72. As a result of multi-layered structure 580 (template 18) having protrusions 72 with a varying width of a second segment 93, separation of multi-layered structure 580 with patterned layer 46, shown in FIG. 2, is facilitated. Effectively, the aspect ratio of a feature, such as the recess and the protrusion, at the place where it is attached to residual layer 48 is lower. Features of higher aspect ratio (thinner critical dimension) have a higher probability of experiencing adhesive/cohesive failure upon separation.

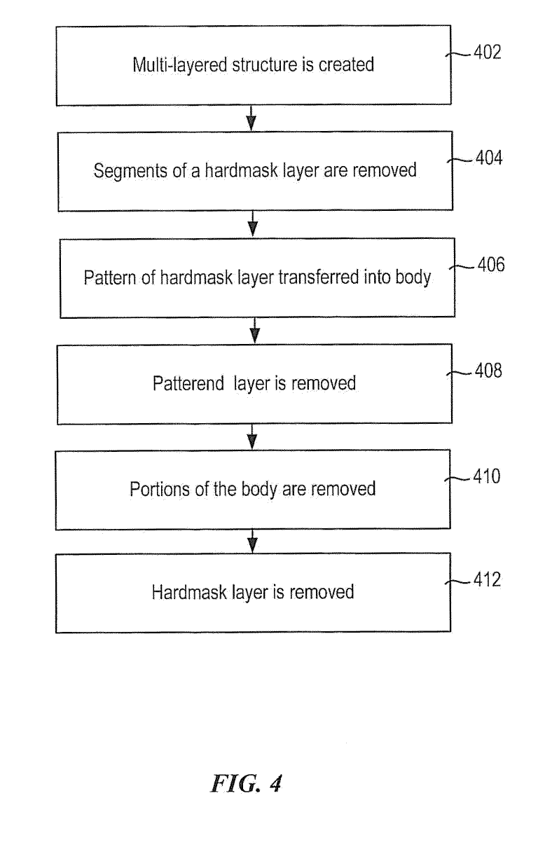

Referring to FIG. 4, a process 400 of creating template 18 is shown. The process 400 is illustrated as a collection of referenced acts arranged in a logical flow graph. The order in which the acts are described is not intended to be construed as a limitation, and any number of the described acts can be combined in other orders and/or in parallel to implement the process.

At step 402, a multi-layered structure is created by positioning a hard mask layer and patterned layer on a body, the hardmask layer being positioned between the body and the patterned layer. Further, the multi-layered structure comprising a plurality of protrusions and recessions, the recession exposing portions of the hardmask layer.

At step 404, segments of the portions of the hardmask layer are removed to define a first width at a first interface of the hardmask layer and the patterned layer and a second width at a second interface of the hardmask layer and the body.

At step 406, a pattern of the hardmask layer is transferred into the body, with the recession in superimposition with the body having the second width.

At step 408, the patterned layer is removed.

At step 410, portions of the body are removed such that the recessions have the second width at a first section of the body; a third width at the second interface; and a varying width at a second section of the body between the first section and the second interface.

At step 412, the hardmask layer may be removed.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A lithographic template comprising:
a body having a plurality of protrusions and recessions, with at least one of the plurality of protrusions comprising a first and a second segment, the first segment having a first width associated therewith and a surface of the at least one protrusion facing away from the body having a second width, differing from the first width, associated therewith, with the second segment having a varying width between the first and the second width.

2. The template as recited in claim 1, wherein the varying width facilitates release of the template from a layer in contact therewith.

3. The template as described in claim 1, wherein the second width is less than the first width.

4. The template as described in claim 1, wherein a variation of the width of the second segment is substantially linear.

5. The template as recited in claim 1, wherein a variation of the width of the second segment varies.

6. The template as recited in claim 1, wherein an angle of the second segment with respect to a horizontal is approximately 45°.

7. The template as recited in claim 1, wherein an angle of the second segment with respect to a horizontal is approximately 45°-60°.

8. The template as recited in claim 1, wherein an angle of the second segment is chosen to facilitate a low release force.

9. A method of forming a lithographic template comprising:
creating a multi-layered structure by positioning a hardmask layer and a patterned layer on a body, the hardmask layer being positioned between the body and the patterned layer, the multi-layered structure layer having a plurality of protrusions and recessions, the recessions having a first width associated therewith and further the recessions exposing portions of the hardmask layer;
removing segments of the portions of the hardmask layer to expose portions of the body, with the recessions at a first interface of the hardmask layer and the patterned layer having the first width associated therewith and the recessions at a second interface of the hardmask layer and the body having a second width, differing from the first width, associated therewith;
transferring a pattern of the hardmask layer into the body such that the recessions in superimposition with the body have the second width associated therewith; and
removing portions of the body such that the recessions at a first section of the body have the second width and the recessions at the second interface have a third width, differing from the first and the second width, associated therewith, with the recessions at a second section of the body, between the first section and the second interface, having a varying width between the second width and the third width.

10. The method as recited in claim 9, wherein the second width is smaller than the first width.

11. The method as recited in claim 10, wherein the second width is smaller than the third width.

12. The method as recited in claim 11, further comprising removing the patterned layer and the hardmask layer.

13. The method as recited in claim 12, wherein the second section of the body facilitates release of the template from a layer in contact therewith.

14. A lithographic template comprising:
a body having a plurality of protrusions and recessions, with at least one of the plurality of protrusions comprising a first and a second segment, the first segment having a substantially constant width associated therewith and a second segment having a varying width associated therewith such that a sidewall of the second segment of the protrusion is angled with respect to a sidewall of the first segment of the protrusion.

15. The template as recited in claim 14, wherein the second segment facilitates release of the template from a layer in contact therewith.

16. The template as described in claim 14, wherein a portion of the varying width of the second segment is substantially linear.

17. The template as recited in claim 14, wherein a variation of the varying width of the second segment varies.

18. The template as recited in claim 14, wherein an angle of the second segment with respect to a horizontal is approximately 45°.

19. The template as recited in claim 14, wherein an angle of the second segment with respect to a horizontal is approximately 45°-60°.

20. The template as recited in claim 14, wherein an angle of the second segment is chosen to facilitate a low release force.
